(19) United States
(12) Patent Application Publication
(10) Pub. No.: US 2012/0318629 A1
(43) Pub. Date: Dec. 20, 2012

(54) LOCKING DIFFERENTIAL HAVING IMPROVED CLUTCH TEETH

(75) Inventor: Randal A. Lyman, Everett, WA (US)

(73) Assignee: RING & PINION SERVICE, INC., Everett, WA (US)

(21) Appl. No.: 13/595,868

(22) Filed: Aug. 27, 2012

Related U.S. Application Data
(63) Continuation-in-part of application No. 12/249,609, filed on Oct. 10, 2008, now abandoned.

(51) Int. Cl. F16D 11/14

(52) U.S. Cl. 192/69.7

(57) ABSTRACT

A hold-out ring type locking differential for an automobile or other type of motorized vehicle includes a differential case housing a number of components, such as a center driver positioned between holdout rings, clutch members, springs, spring retainers, side gears, and thrust washers. The center driver includes a center cam that engages inner teeth of the clutch members, which in turn include a tooth shape or profile for reducing stress and wear while increasing an operational life of the clutch member. The inner clutch teeth each have a top portion coupled to a base portion at an intersection point. The top portion extends from the intersection point to a free edge surface while the base portion extending from the intersection point continually into a root radius region.

### PRIORITY CLAIM

This application is a continuation-in-part of prior application Ser. No. 12/249,609, filed Oct. 10, 2008, the contents of which are incorporated by reference.

### FIELD OF THE INVENTION

This invention relates generally to a locking differential system of a hold-out-ring type having clutch members selectively engageable with a center driving member.

### BACKGROUND OF THE INVENTION

Differentials for automotive-type applications are used in many front or rear axles to transmit the power from the engine to the driven wheels of the vehicle. Conventional differentials permit a vehicle to turn corners with one wheel rolling faster than the other and generally include two side gears coupled to the output or driven shafts, which in turn are coupled to the respective left and right wheels of the vehicle. The differential case generally includes a ring gear driven by a pinion gear coupled to an end of the vehicle drive shaft driven by the engine. Side gears are located within and coupled to the differential case while typically being splined or otherwise coupled to the respective driven shafts. The side gears may be controlled by various means to permit the driven shafts to power both wheels during most vehicle maneuvers. But when turning, this arrangement of the differential permits the outer wheel to overrun (i.e., rotate faster than) the inner wheel, which lags (i.e., rotates slower). The amount of overrun rate is generally equivalent to the amount of lag.

There are a variety of differential types such as conventional or “open” differentials, limited slip differentials, and lockable or locking differentials. These types are distinguishable by how they handle various possible operating conditions.

Locking differentials contain mechanisms and features which cause the differential to prevent or limit rotational speed differences between the left and right driven wheels. Different methodologies are used to actuate these mechanisms. The most common means for actuation of the mechanism in a locking differential are pneumatic, hydraulic, electric, electromechanical, mechanical friction or some combination thereof.

In addition, at least some of these differentials may be characterized as hold-out ring type differentials in which a center driving member engages a pair of clutch members. The center driving member and the clutch members each have corresponding sets of engagement teeth, for example an inner set of clutch cam teeth and an outer set of engagement teeth. Spring devices may be or may not be employed to outwardly bias side gears in an axial direction within the differential. One type of hold-out ring type differential is described in U.S. Pat. No. 6,076,429 to Valente, which teaches that at least one set of the clutch cam teeth are trapezoidally configured to reduce stress in the teeth. As shown in FIGS. 1A and 1B, the '429 patent further teaches a clutch member 10 includes trapezoidally configured inner clutch cam teeth 12 that are complementarily formed with respect to corresponding teeth on a center cam driving member (not shown). Accordingly, the '429 patent teaches there is little or no space between the teeth 12 and the teeth of the center cam member (not shown) when engaged. As discussed in the '429 patent, the trapezoidally-shaped inner teeth 12 of the clutch member 10 are intended to be an improvement over conventional clutch teeth, which are illustrated in FIG. 1C on clutch member 14 as dove-tail shaped teeth 16. Some other conventional differentials of the hold-out ring type are described in U.S. Pat. No. 3,791,238 (Bokovoy); U.S. Pat. No. 4,424,725 (Bawks); U.S. Pat. No. 4,557,158 (Dissett et al.); U.S. Pat. No. 4,745,818 (Edwards et al.); and U.S. Pat. No. 5,524,509 (Dissett).

### SUMMARY OF THE INVENTION

The present invention is generally related to a locking differential of the hold-out ring type having a center driving member that includes a center cam and where the center driving member engages a pair of clutch members. Each of the clutch members may have an inner set of clutch cam teeth and an outer set of engagement teeth. During an overrun condition, the inner set of clutch cam teeth cooperate with corresponding teeth on the center cam to disengage the clutch member from the center driving member. In one embodiment, the inner set of clutch cam teeth of the clutch members are configured such that top portions of the teeth are couple to filleted base regions or root radius regions through intersection points.

In one example, a differential system for disengaging an overrunning output shaft from a center driving member includes a differential case having a cavity for receiving the center driving member, the center driving member having a center cam. An annular clutch member is located within the cavity and arranged for engagement with the center driving member. The clutch member includes a plurality of outer clutch engagement teeth extending from a first surface and configured to engage corresponding teeth on the center driving member of the differential. The clutch member further includes a plurality of inner clutch cam teeth extending from a second surface and operable to disengage the outer clutch engagement teeth from the center driving member. The inner clutch cam teeth each have a top portion coupled to a base portion at an intersection point. The top portion extends from the intersection point to a free edge surface. The base portion extends from the intersection point continually into a root radius region that further transitions into the second surface.

In another example, a clutch member for a differential system includes a plurality of outer clutch engagement teeth extending from a first surface and configured to engage corresponding teeth on a center driving member of the differential system. The clutch member further includes a plurality of inner clutch cam teeth extending from a second surface and operable to disengage the outer clutch engagement teeth from the center driving member. The inner clutch cam teeth each have a top portion coupled to a base portion at an intersection point. The top portion extends from the intersection point to a free edge surface. The base portion extends from the intersection point continually into a root radius region that further transitions into the second surface.

### BRIEF DESCRIPTION OF THE DRAWINGS

Preferred and alternative examples of the present invention are described in detail below with reference to the following drawings:

Various embodiments are briefly described with reference to the following drawings:

FIG. 1A is a side elevational view of a prior-art clutch member;

FIG. 1B is a cross-sectional view of the prior-art clutch member of FIG. 1A taken along line 1B-1B of FIG. 1A having trapezoidally-shaped clutch teeth;

FIG. 1C is a cross-sectional view of a prior-art clutch member having dove-tail shaped clutch teeth;

FIG. 2 is an isometric exploded view of a differential system having clutch members engageable with a center driving member according to one illustrated embodiment of the invention;

FIG. 3 is an isometric view of one of the clutch members of FIG. 2 according to an illustrated embodiment of the invention;

FIG. 4 is a side elevational view of the clutch member of FIG. 3;

FIG. 5 is a cross-sectional view of the clutch member of FIG. 4 taken along line 5-5 of FIG. 4; and

FIG. 6 is a close-up view of an inner tooth of the clutch member of FIG. 4.

### DETAILED DESCRIPTION OF THE PREFERRED EMBODIMENT

In the following description, certain specific details are set forth in order to provide a thorough understanding of various embodiments of the invention. However, the invention may be practiced without these details or with various combinations of these details. In other instances, well-known structures and methods associated with differential systems, driving and output mechanisms for the differential systems, and sub-assemblies located within a housing or case of the differential system, and methods of assembling, operating and using the same may not be shown or described in detail to avoid unnecessarily obscuring descriptions of the embodiments of the invention.

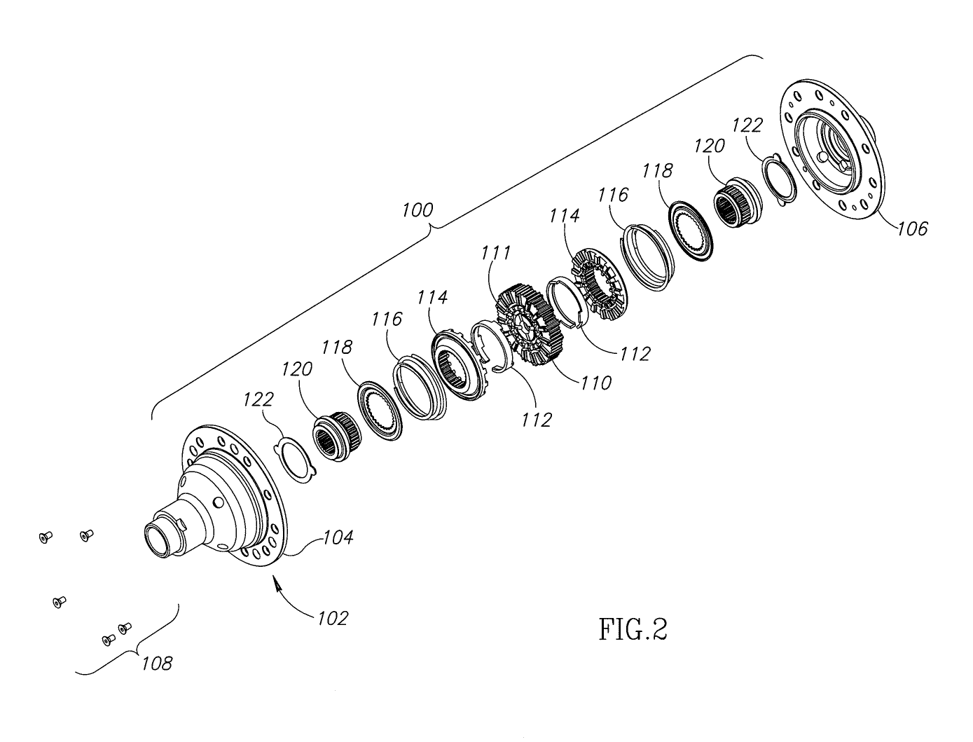

FIG. 2 shows an embodiment of the present invention that takes the form of a hold-out ring type locking differential 100 for an automobile or other type of motorized vehicle. The hold-out ring type locking differential 100 includes a differential case 102 having a first case half 104 coupled to a second case half 106 with fasteners 108 or some other type of mechanical connection for connecting the two halves 104, 106. Within the case 102, the differential 100 includes a center driver 110 positioned between holdout rings 112, clutch members 114, springs 116, spring retainers 118, side gears 120, and thrust washers 122. The center driver 110 includes a center cam 111 that engages inner teeth of the clutch members 114. These aforementioned components, except for the clutch members 114, may be substantially similar or even identical to like components found in a conventional, hold-out ring type differential. The clutch members 114, and in particular the inner teeth thereof, shall now be described in more detail below.

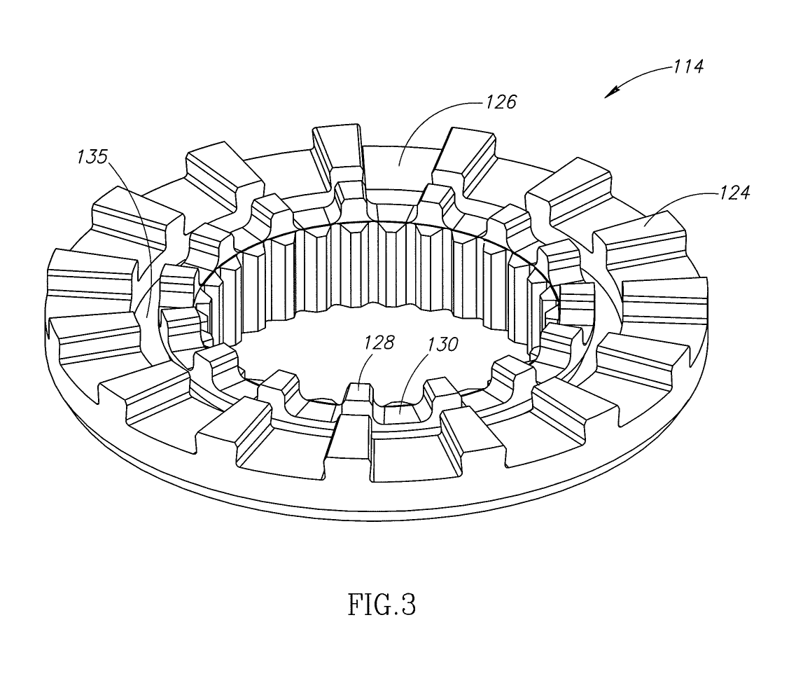

FIGS. 3, 4 and 5 shows one of the clutch members 114 having a plurality of outer clutch engagement teeth 124 extending from a first surface 126 and configured to engage corresponding teeth on the center driving member 110 (FIG. 2) of the differential system 100 (FIG. 2). The clutch member 114 further includes a plurality of inner clutch cam teeth 128 extending from a second surface 130 (FIG. 5) and operable to disengage the outer clutch teeth 124 from the center driving member 110. The inner clutch cam teeth 128 each include a top portion 132 coupled to a base portion 134. A groove 135 is located between the outer clutch engagement teeth 124 and the inner clutch cam teeth 128 and is configured to receive the holdout ring 112.

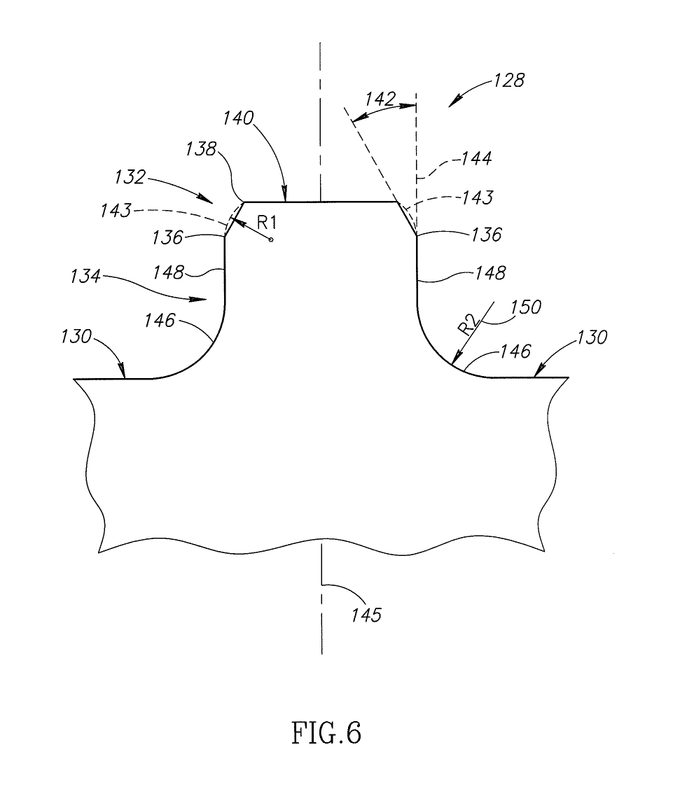

As best seen in FIG. 6, the top portion 132 of the tooth 128 extends from a first intersection point 136 toward a second intersection point 138 adjacent an end surface 140 of the tooth 128. With respect to the first and second intersection points 136, 138, the top portion 132 may be positioned at an angle 142. The angle 142, as measured from a hypothetical vertical line 144, may be any angle that is more or less parallel to the corresponding surfaces of the mating center cam 111 teeth. Also, instead of an angle 142, a radius 143 may start at the intersection 138 while extending tangentially from the surface 140, and then continue into the intersection 136 and end up tangent to the surface 148.

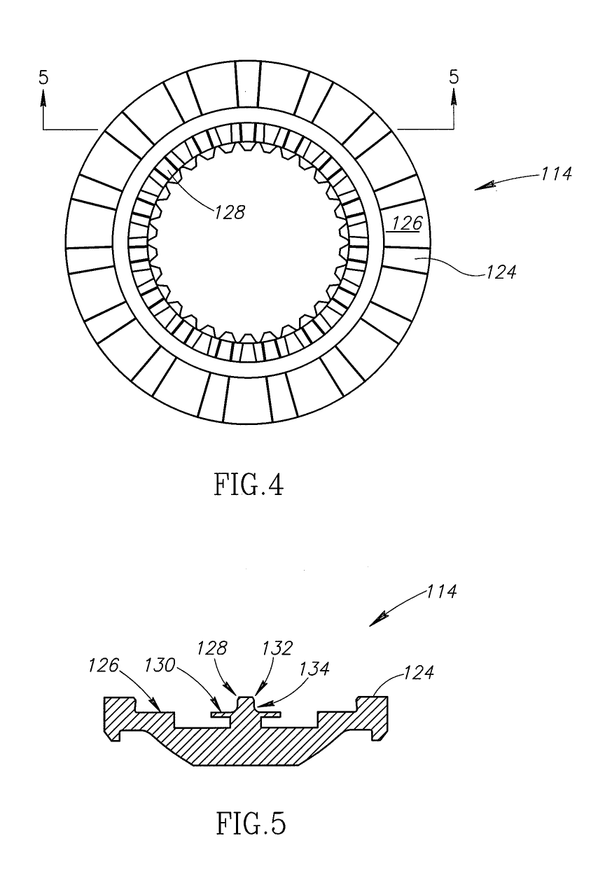

The base portion 134 extends from the first intersection point 136 into a fillet or root radius region 146, which in turn continually transitions into the second surface 130 (FIG. 4). In one embodiment, an upper portion 148 of the base portion 134 may be substantially straight relative to the vertical line 144 as it transitions into the root radius region 146. By way of example, the vertical line 144 may be substantially parallel to a longitudinal line 145 that corresponds to a length of the tooth 128. In another embodiment, the upper portion 148 gradually curves into the root radius region 146. A radius “R2” as indicated by line 150 of the root radius region 146 may be any suitable value within a range of about 0.5 mm to 2.5 mm; and preferably about 1.5 mm.

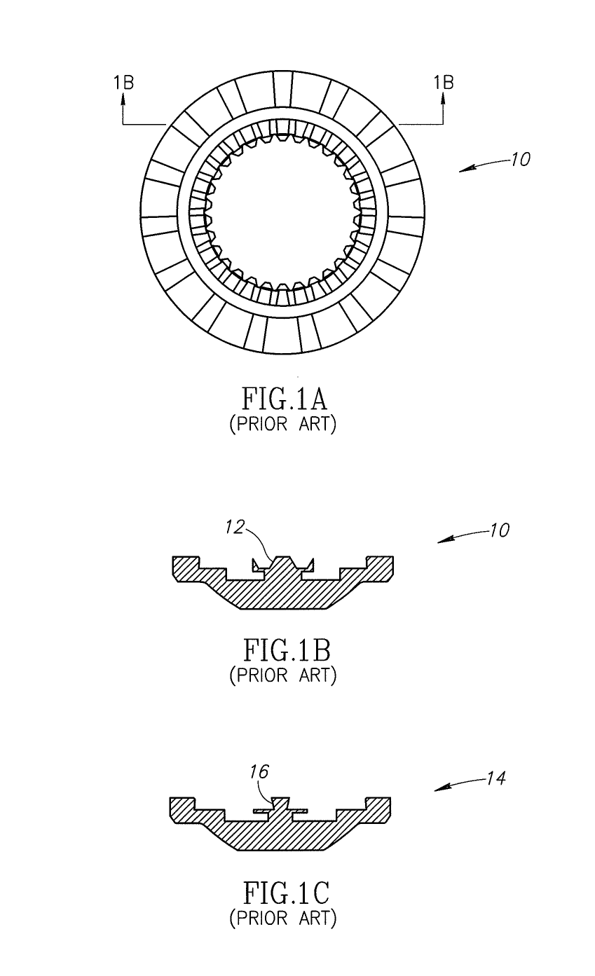

The shape of the inner clutch teeth 128 includes straight, but optionally angled or radiused top portions 132 and a more or less large root radius region 146. Such a configuration may advantageously reduce the stress caused by applied load and other loads compared to the conventional tooth configuration shown in FIG. 1C, this is similar to or better than the strength advantage offered by the trapezoidal tooth configuration shown in FIG. 1B. Likewise, the reduction in stress over an operational life of the clutch member 114 may substantially extend the life of the clutch member, thus reducing repair, maintenance and/or replacement costs. Another possible advantage of the tooth shape of the inner clutch member teeth 128 is that the large root radius region 146 permits better management of a hardened case thickness applied to the teeth 128 during heat treatment after machining of the teeth 128. Further, the tooth shape offers a reduction in friction between the center cam 111 and the inner teeth 128 of the clutch members 114 at least in part because the tooth shape may advantageously decrease a surface contact area as compared to the tooth shapes shown in FIG. 1B. As such, the shape of the teeth 128 permits the clutch members 114 to start ramping up the center cam 111 with a lower amount of applied torque while generating little to no increase in wear or fatigue damage.

In accordance with a preferred version for producing the claimed invention, a process begins with a circular stock steel material such as AISI 8620 or similar grade steel formed as a disk-shaped blank. The blank may be formed on a lathe or otherwise machined to produce a disk shape to form the clutch member. The interior of the blank is hollow to create a donut shape, either because the interior was not part of the stock material in the first place or because it is milled away after creating the disk-shaped blank.

The blank is then inserted into a fixture to securely hold the blank for the creation of the teeth on a CNC milling machine. The outer teeth are formed using a cutter having a vertical side as described above or, in one version, with a cutter having a fived degree dovetail shape. The inner teeth are milled with a ball-shaped cutter (preferably with a 3 mm diameter) to form the large root radius of the inner teeth. The chamfer at the top of the teeth is then milled, either with a straight angled side or with a radiused edge as described above. After tooth milling is complete, the inner splines of the clutch member are formed using a broach.

Once the milling is finished, the clutch member is heat treated in a process that includes a first carburizing step, then quenching and tempering. The shape of the teeth, as described above in accordance with the preferred embodiment, brings significant advantages when combined with the heat treatment steps. In prior art teeth having an inward tapered base forming a dovetail, the cross section of the base of the tooth is quite narrow. As a result, the heat treatment intended to harden an outer portion of the clutch member results in a brittle tooth, including at the base, which can lead to tooth fracture in use. By contrast, the outer teeth in accordance with the preferred versions as described above have a substantially straight sidewall and a rounded root radius. The combination produces a larger tooth base with a straight-sided tooth. After heat treatment, the larger interior area at the base of the tooth allows for a hardened outer surface of the tooth and simultaneously a relatively thick interior area forming a large and more ductile core. The tooth is therefore hardened for improved wear resistance but has a softer core to reduce the likelihood of fracturing.

With reference to FIG. 6, the radiused base of the tooth preferably continues from the flat base of the clutch member upward to a location that is half way or approximately half way between the base and the top of the tooth. At that point, the tooth has substantially vertical sides (or, in some versions, a slight dovetail of about 5 degrees or less) extending upward to the top of the tooth other than a chamfered corner as described above.

In some versions of the invention, both sets of teeth or only the inner teeth may be forged rather than milled. The sharply dovetailed prior art designs are not capable of being forged because a forging die cannot produce the back angle of the teeth. Likewise, a forging die cannot produce sharp angles at the tooth radius, but may be able to produce a rounded root radius, particularly where the tolerance at the root is not critical.

Many other changes can be made in light of the above detailed description. In general, in the following claims, the terms used should not be construed to limit the invention to the specific embodiments disclosed in the specification and the claims, but should be construed to include all types of differentials, gears, gear systems, actuation systems, differential cases, preloaded thrust assemblies and methods of assembling the same that operate in accordance with the claims. Accordingly, the invention is not limited by the disclosure, but instead its scope is to be determined entirely by the following claims.

The embodiments of the invention in which an exclusive property or privilege is claimed are defined as follows:

1. A differential system for disengaging an overrunning output shaft from a center driving
member, the differential system comprising:
a differential case having a cavity for receiving the center driving member, the center driving member having a center cam;
an annular clutch member located within the cavity and arranged for engagement with the center driving member, the clutch member having a plurality of outer clutch teeth extending from a first planar surface and configured to engage corresponding teeth on the center driving member of the differential, the clutch member further having a plurality of inner clutch teeth extending from a second planar surface and operable to disengage the outer clutch teeth from the center driving member, the inner clutch teeth each having a top portion coupled to a base portion at an intersection point, each of the teeth extending upward from the base portion toward the top portion along a respective central axis, the top portion extending from the intersection point to an end surface, the base portion extending from the intersection point to the second planar surface to define a sidewall that is parallel to the central axis and transitioning to a continual radius of curvature defining a root radius region.

2. The differential system of claim 1, wherein the root radius region extends from the base portion upward to a location half way between the base and the top of the tooth.

3. The differential system of claim 1, wherein the top portion includes a radius extending tangentially from the end surface to the intersection point.

4. The differential system of claim 1, wherein the intersection point is located at approximately halfway between the end surface and the second surface.

5. The differential system of claim 1, wherein the center cam includes teeth configured to complimentarily engage the inner teeth of the clutch member.

6. A clutch member for a differential system, the clutch member comprising:
a plurality of outer clutch teeth extending from a first planar surface and configured to engage corresponding teeth on a center driving member of the differential system; and
a plurality of inner clutch teeth extending from a second planar surface and operable to disengage the outer clutch teeth from the center driving member, the inner clutch teeth each having a top portion coupled to a base portion at an intersection point, each of the teeth extending upward from the base portion toward the top portion along a respective central axis, the top portion extending from the intersection point to an end surface, the base portion extending on each opposing side from the intersection point to define a pair of opposing sidewalls that are parallel to the central axis and transitioning to a root radius region that further transitions into the second planar surface;
wherein the clutch member is heat treated to form a hardened outer surface of the inner clutch teeth and a relatively softer inner core of the inner clutch teeth, whereby the relatively soft inner core of the inner teeth is larger at the root radius region than at the top portion.

7. The clutch member of claim 6, wherein the base portion is configured to reduce an amount of stress caused by operational loads within the differential system.

8. The clutch member of claim 6, wherein the top portion includes a radius extending tangentially from the end surface to the intersection point.

9. The clutch member of claim 6, wherein the inner teeth are formed by forging the teeth from a metal blank.
